(19) United States
(12) Patent Application Publication
(10) Pub. No.: US 2012/0267215 A1
(43) Pub. Date: Oct. 25, 2012

(54) DEVICE FOR THE ACCEPTANCE OF COINS

(75) Inventors: Roland Mührenberg, Lubeck (DE); Danis Shageev, Bad Oldesloe (DE); Marko Zander, Kiel (DE)

(73) Assignee: Novomatic AG, Gumpoldskirchen (AT)

(21) Appl. No.: 13/388,960

(22) PCT Filed: Aug. 4, 2010
(86) PCT No.: PCT/IB2010/001940

§ 371 Date: Jun. 21, 2012

(30) Foreign Application Priority Data
Aug. 5, 2009 (DE) 20 2009 010 573.3
Nov. 20, 2009 (DE) 20 2009 015 900.0

(51) Int. Cl. G07F 1/04; G07F 1/02

(52) U.S. Cl. 194/347; 194/350; 194/344

(57) ABSTRACT

Device for the acceptance of coins which allows the acceptance of individual coins as well as the acceptance of various coins for further processing of the coins, whereby the device is a drawer-like, laterally moveable holding fixture (5, 10, 14), which is characterised by the drawer-like holding fixture (5, 10, 14) having a on the one side a coin insertion slot (4) and an receptacle area (10, 13, 14) for the reception of a plurality of coins.

The invention refers to a device for the acceptance of coins in accordance with the preamble of claim 1.

For the processing of large coin quantities there are currently different insertion systems for devices for the processing of coins, such as, for example, coin counting devices and/or coin acceptance devices or similar. Some of these devices are operated with a coin flap, which when opening and folding have an insertion cup on the back side, which collects the coins and which conveys these to the device downwards when folding back.

The US 2004/0011620 A1 is a coin device whereby the coin is placed into a tiltable slot in order to process it there. The coins are deposited there and with the tilting of the slot they are fed in for further processing.

With other familiar devices the coins are inserted individually through a coin slot in the device, which is not easily operable with big quantities of coins.

With other solutions, for example, more coins can be fed into the device than can flow out or can be processed. This results in a congestion of the coins which makes the acceptance process difficult.

Often the usual realisations have an extra insertion slot for individual coins at a different part of the device or they have no slot for individual insertion of coins. If there is no slot for individual insertion, then by using the receptacle of large coin quantities the insertion of individual coins is made more difficult, so the insertion through the coin slot is quick and straightforward.

Also, often the devices with their coin acceptance arrangement cannot be locked, so that unauthorised access to the device through manipulation is possible.

A further problem is that unintentionally or intentionally liquids can be filled into the machine. These liquids can compromise mechanical or electronic parts of the machine or even destroy these. A similar problem is the insertion of foreign particles into the machine.

It is an object of the invention to provide a device as mentioned above, which at least reduces the disadvantages of the current state of technology.

This is achieved with the feature of claim 1, whereby a device for accepting of coins, which allows the acceptance of individual coins as well as the acceptance of various coins for the further processing of the coins via a coin outlet, whereby the device is a drawer-like, laterally moveable holding fixture, characterised in that the drawer-like holding fixture comprises on one side a coin insertion slot and a receptacle area for the reception of a plurality of coins.

The individual coins can therefore be easily inserted through the coin insertion slot and a plurality of coins can be put or poured into the tray-like holding fixture.

Furthermore it is advantageous, if the front side with the coin insertion slot is also accessible if the tray-like holding fixture is in a closed position. This allows the use of small number of coins without opening the drawer-like device.

It is also advantageous, if the tray-like holding fixture for the acceptance of a plurality of coins is only accessible in an opened position of the drawer-like holding fixture. This safeguards against usage for other purposes than intended, in particular with closable devices.

It is thereby very advantageous, if the drawer-like holding fixture is designed in a laterally moveable manner with pull-out rails. This also ensures safe functionality even with highly loaded holding fixtures. According to the preferred embodiment it is foreseen that the drawer-like holding fixture is moveable horizontally or, in particular, with an angle of 90° to the vertical axis of the holding fixture.

It is particularly advantageous, if with the insertion of objects other than intended at least a filter is foreseen, which consequently sorts the foreign object out after the acceptance so that these do not get into the coin channel.

It is also advantageous if with the design of the tray and/or the filter a flawless coin outlet is guaranteed.

It is furthermore practical, if the filter is inclined towards the tray bottom so as to guarantee a flawless coin outlet. By doing so, with a simple design an advantage is created regarding the transport of coins.

It is also practical, if at least a filter is foreseen for the diversion of liquids, so that thereby an effluence of liquids is guaranteed and the inner design is not endangered by the liquid.

It is particularly practical, if a sensor is foreseen which detects if a liquid was filled in and in such an event a signal is sent to a control which generates a corresponding warning.

The invention is designed practically, whereby through a filter smaller objects can be filtered, so that these cannot enter the coin channel.

It is furthermore practical, if through a sensor it is identified if a foreign object has been inserted into the device and if with the corresponding filling level a service notification is generated.

It is also advantageous if the coin processing only starts once the filling procedure is completed.

It is furthermore advantageous, if the maximum amount of coin per filling procedure is limited by the design of the tray.

The solution presented solves or reduces to a large extent the above-mentioned problems of current realisations.

The above mentioned aspects and other aspects of the invention emanate from the embodiments below and are explained with these embodiments.

The invention will be further described below with reference to exemplary embodiments illustrated in the drawings, but to which the invention is not limited. They show:

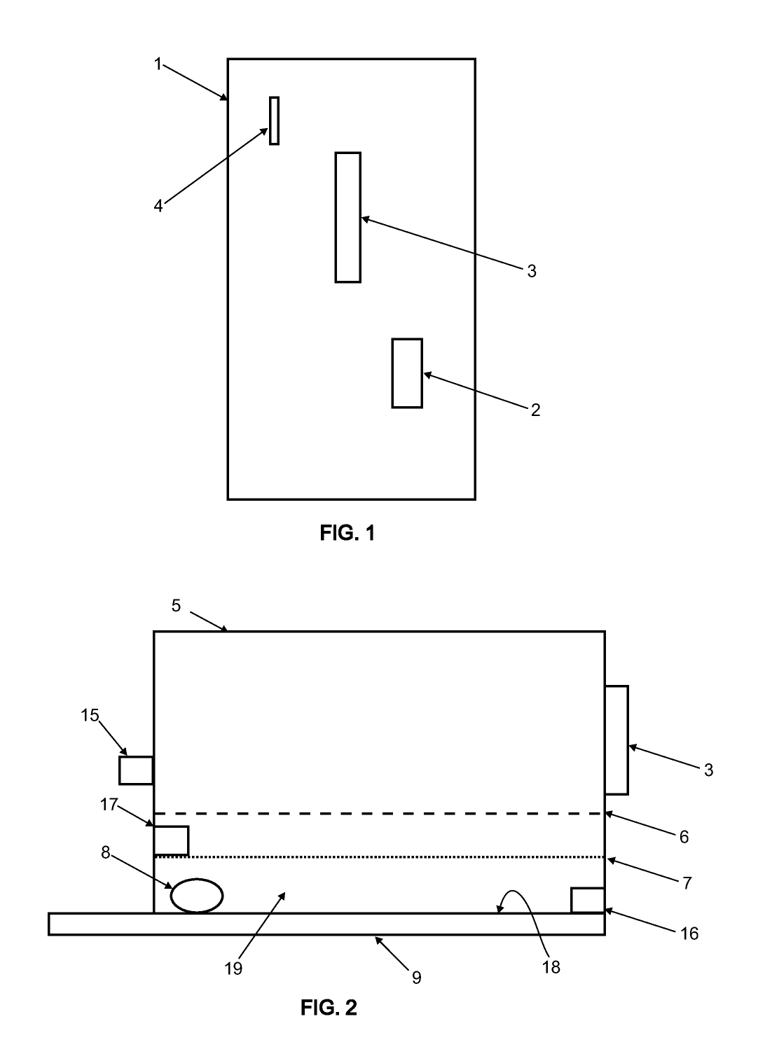

FIG. 1 a front view of the drawer,

FIG. 2 a lateral view of the drawer,

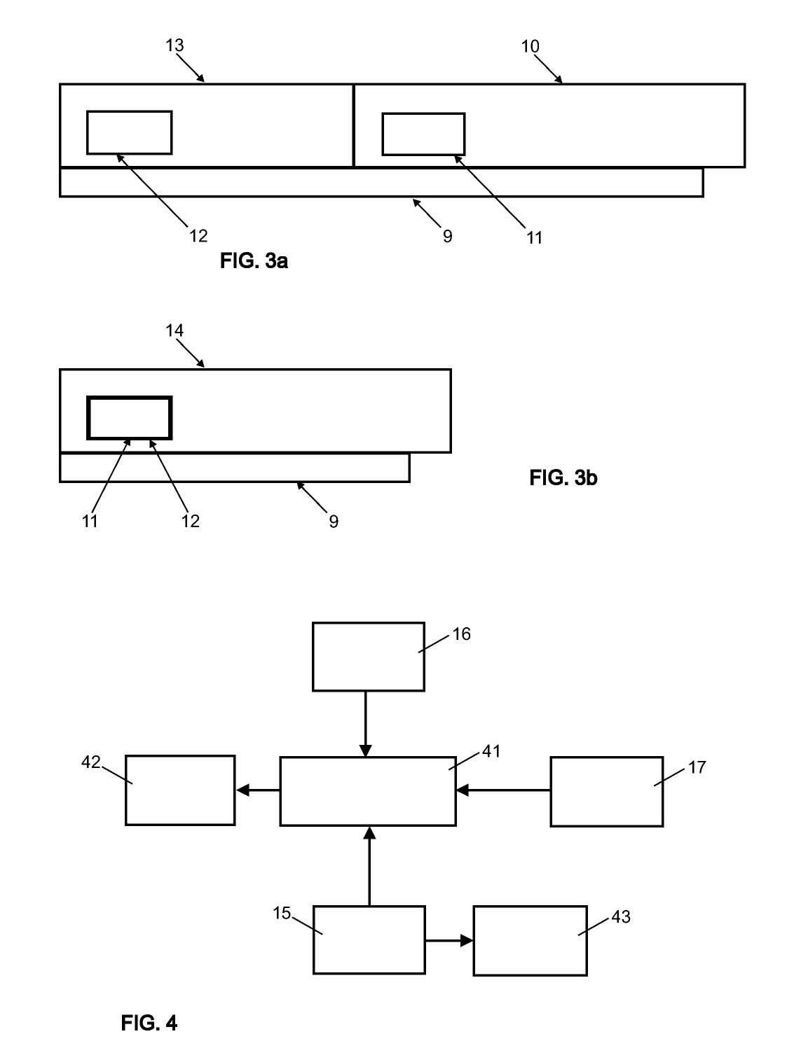

FIGS. 3a and 3b in each case a further processing mechanism, and

FIG. 4 in a schematic representation the central control, and

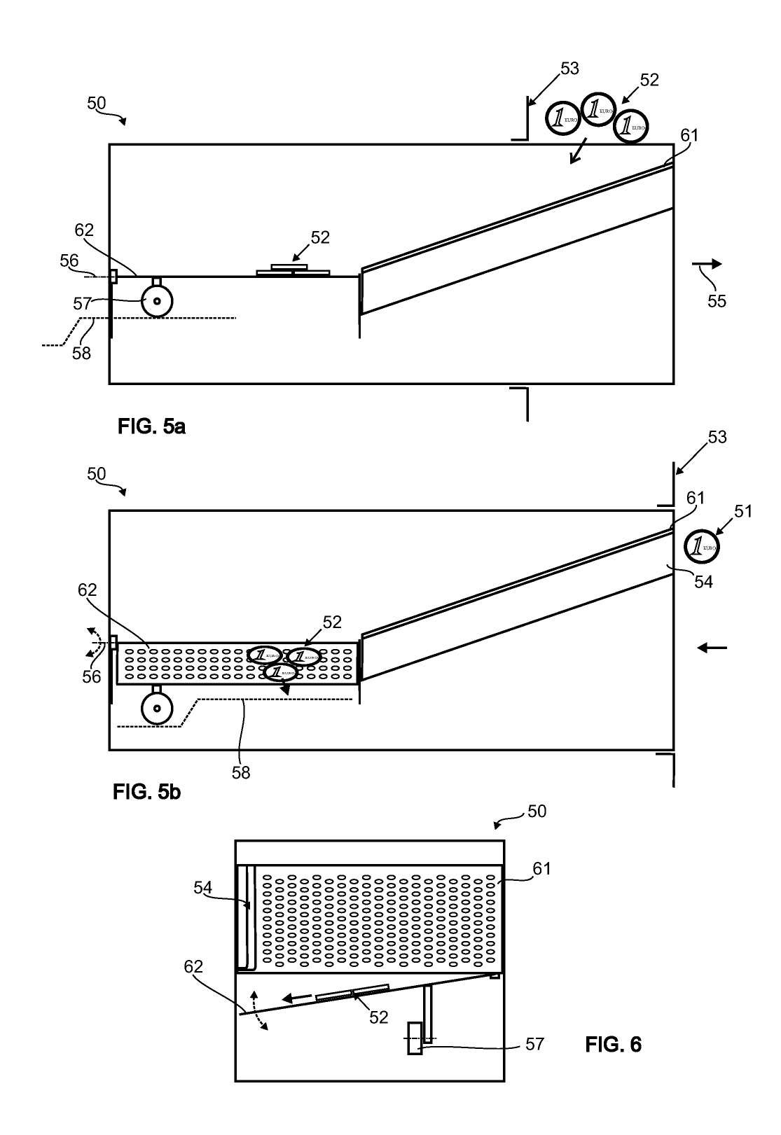

FIGS. 5a, 5b and 6 a further embodiment of the device in accordance with the invention in different operating positions and different drawing views.

FIG. 1 shows schematically a part of a device in accordance with the invention with a holding fixture for individual coins or for a plurality of coins. It may be stated that instead of coins also other bodies can be used, for example, square coins, chips etc.

The holding fixture thereby is designed as a drawer or drawer-like, laterally moveable holding fixture device 1, which can be at least pulled out partially from the device by an operator. FIG. 1 shows thereby a laterally extractable drawer in a frontal view, viewed from the operator's point of view.

For protection against theft or for the protection against vandalism or destruction the drawer-like, laterally moveable holding fixture can be secured in its position with the fitting of at least one lock 2, which prevents unauthorised access to the coin drawer. With the lock the drawer is secured in its not pulled-out position and the unauthorised pulling-out is prevented. Thereby the drawer is protected in its pulled-out position from fouling and destruction, as in this position the biggest damage to the drawer is possible.

For example, with a closed drawer or drawer-like holding fixture device 1 the operation can be organised as follows: when using the coin acceptance for large coin quantities it may be advantageous to have security guards of a financial institution or of an amusement arcade to open the drawer or the drawer-like holding fixture manually with a key. Also, an electronically controlled opening of the security measures may be possible.

Alternatively, individual operators may be equipped with a key, as on principle it can be assumed that the operators themselves appreciate a safe functioning of the device and would not endanger it.

The device is designed in such a manner that the application of a lock is optional. According to the application a lock may be provided or not. On principle this allows the usage without security guards, if it is desired.

For the opening of the front side of the drawer-like holding fixture a handle 3 is provided which is meant to facilitate the manual opening. As considered advantageous, the handle 3 may be applied horizontally or vertically at the front of the drawer-like holding fixture. A cover plate or an end plate constitutes the front side of the drawer-like holding fixture and this blocks the access to the inside of the drawer-like holding fixture, if it is in closed position.

The reference sign 4 shows an insertion slot for individual coins. This insertion slot is designed in such a manner so that advantageously only coins intended for such purpose can be inserted into the device. It may be either directly connected to a channel for coins or as presented in FIG. 2 the insertion into the entire tray may occur. In such an event the coins would have been inserted through the insertion slot and would have fallen directly into the tray situated below. Optionally the insertion slot is located on the front side of the drawer and allows the coin insertion also with a closed drawer.

FIG. 2 shows a drawer-like holding fixture in accordance with the invention or the drawer from the side in the corresponding lateral view 5. Advantageously there are filters provided in the interior of the drawer-like holding fixture, which filters protect from unserviceable objects and drains off these. Advantageously there is at least one filter or there are also two filters 6, 7 installed. A coarser grained filter 6 may be provided and serves so that the coins are transferred, but smaller particles are transported to the deposit situated below (due to gravity). This first filter 6 is the upper filter of the provided two filters 6, 7 with the embodiment.

A finer filter 7, which is situated below the coarse grained filter 6, ensures that at least liquids can be drained off. These are then drained off through a liquid outlet 8. The liquid outlet may be created with a tube, which leads to a bigger container and there allows the collection of liquid.

The area below the coarse grained filter 6 is designed as a tray 19 with a bottom 18 and with side panels.

Advantageously below the finer filter 7 a humidity sensor 16 is installed, which is connected with a central control 41 of the system (compare FIG. 4). This humidity sensor 16 signals the control 41 of the system regarding the penetration of humidity and actuates the corresponding actions. These may range from, for example, warning notices on the screen 42 to the shut-down of the system in order to protect the system (compare FIG. 4). The humidity sensor 16 is conveniently installed in such a manner that it facilitates an easy wiring with the central control 41 of the system. The foreign object sensor 17 (see FIG. 4) is installed in a similar manner. It sends service notices that foreign objects have been detected. Also, alternatively a diversion of the foreign object into a counterfeit money channel, which is not shown, is possible.

A micro switch 15 or similar ensures the activation of the electronic system and the mechanical system 43 for the further processing of coins. The micro switch may be installed on the front or rear side, as in FIG. 2, of the drawer.

FIGS. 3a and 3b show in what manner the outlet of coins is designed. The drawer is connected to a sliding rail. When the drawer is opened it is possible to insert the coins 52 through an opening. The coins are then in an receptacle area, but cannot be skimmed or cannot be outlet through the opening 11. The opening 11 in the moveable part is covered by a part of the plate of the unmoveable part 13 of the drawer, see also FIG. 3. Only if the moveable part of the drawer coincides 14, the coinciding openings 11 and 12 allow an outlet of the coins. Thereby it is prevented that more coins than can be contained in the drawer are fed in or that more coins than can be processed by the entire system are fed in.

Advantageously, the level of the filter 6 in FIG. 2 plays a supportive role. Therefor the surface of filter 6 is not installed in a parallel manner to the tray bottom 18, but is in an inclined angle to the latter. Thereby the filter surface of the filter 6 is inclined and supports the outlet of the coins. This inclination is designed in such a manner so that a flawless outlet into the coin channel 12 is guaranteed and therefore no blockades of coins in the coin drawers are possible.

The FIGS. 5a, 5b and 6 show a further embodiment of the device in accordance with the invention with a mounting fixture 50 for individual coins 51 or for a plurality of coins 52.

FIG. 6 shows schematically (in pull-out direction) the laterally sliding drawer from FIG. 5a, 5b in a front view without the front cover.

The mounting fixture 50 is thereby designed as a drawer or a drawer-like, laterally sliding mounting fixture, which may be at least partially pulled out by an operator of a (schematically shown) housing 53 of a coin changer, as is shown schematically in FIG. 5a. Furthermore the mounting fixture 50 has a coin channel 54 through which individual coins inserted in the slot 4 can be transported.

The mounting fixture 50 shows furthermore a coin outlet area which also, as described in connection with FIG. 2, has an inclination for the support of the gravitational transport of the coins 51, 52.

In this particular case the coin outlet area has an unmoveable (fixed) part 61 in relation to the drawer and a moveable part 62. The moveable part 62 is thereby designed and arranged around an axis 56 parallel to the direction of movement 55 of the drawer, so that the unmoveable part 61 is connected directly with a lower end to it. The unmoveable part 61 is overall installed in an inclined angle so that the gravitational transport of coins 52 inserted into the drawer is possible.

The moveable part 62 is coupled with a guide wheel 57, this guide wheel 57 follows the guide 58. In this particular case the guide wheel 57 follows the guide 58 gravitationally by the weight of the moveable part 62. The guide 58 is designed and arranged in such a manner that with an opened drawer the moveable part 62 is basically put into a horizontal position (compare FIG. 5a) and with a closed drawer it is basically put into an inclined position (compare FIG. 5b and FIG. 6). It may be mentioned that the moving of the moveable part can also be undertaken with the help of an electro-mechanical motor, whereby a control device is provided which can control the electro-mechanic motor in such a manner that the moveable part 62 is either put into a horizontal or inclined position.

In an opened drawer position coins 52 inserted into the drawer through the unmoveable part 61, initially come to lay in the moveable part 62 brought into the horizontal position. With a closed drawer the moveable part 62 is in an inclined position, so that a sliding of the coins into a further (here not shown) channel for sorting and counting or processing is possible.

In a further embodiment an automatic blocking or locking of the drawer during the processing of coins without the usage of a lock 2 for the locking of the drawer may be foreseen. Counting commences with a slid-in drawer and may be carried out so long until there are no more coins detected in the counting or sorting unit. During this time the drawer is locked and cannot be pulled out. By doing so, an overrun of the counting and sorting unit by all the time opening, filling and closing of the coin drawer is prevented. Therefore the filling level of the counting or sorting unit is determined with a filling level sensor and a filling level signal is given. Depending on the filling level an electro-mechanical bar is locked or opened. This electro-mechanical latch can be, for example, in operative connection with the rear part of the drawer. The electro-mechanical latch may have an angle for the locking. The locking may be designed and installed in the drawer in such a manner so that the coin drawer may be partially opened.

If the counting procedure is completed the counting unit stops and the locking is freed so that the next lot of coins may be filled in. The operator may require that the drawer can be pulled out again. This notification may occur acoustically through a voice response or a sound and/or through a notification on the operator screen 42.

It may also be foreseen that a particular amount of time (Time Out) is awaited after the last completed counting procedure until the inserted and already sorted coins are changed. The coin drawer may be locked in the interim until the payback is completed.

### REFERENCE SIGN LIST

1 Holding fixture
2 Lock
3 Handle
4 Coin insertion slot
5 Drawer view
6 Dirt filter
7 Liquid filter
8 Liquid outlet
9 Sliding rail, pull-out rail
10 Coin drawer moveable part
11 Opening for coins (closed by a sheet metal wall)
12 Opening for coins (open)
13 Fixed part of the coin drawer
14 Coin drawer (moveable and unmoveable part are installed in the cover)
15 Micro switch or similar
16 Humidity sensor
17 Particle sensor
18 Tray bottom
19 Tray
41 Central control
42 Screen
43 Electronics and mechanics for the further processing of coins
50 Mounting fixture
53 Housing
54 Coin channel for individual insertion of coins
55 Direction of movement of the drawer
56 Axis of rotation for the moveable part
57 Guide wheel
58 Guide
61 unmoveable part of the coin outlet area
62 moveable part of the coin outlet area

1-14. (canceled)

15. A device for accepting coins, comprising:
a holding fixture comprising a drawer that is able to slide from an open configuration to a closed configuration;
the holding fixture includes a coin insertion slot for receiving individual coins when the drawer is in the open configuration and when the drawer is in the closed configuration; and
the holding fixture includes a coin opening for receiving multiple coins when the drawer is in the open configuration,
wherein sliding the holding fixture from the open configuration to the closed configuration enables multiple coins to simultaneously enter the device for accepting coins.

16. The device as set forth in claim 15, wherein the holding fixture includes rails to enable the holding fixture to slide.

17. The device as set forth in claim 15, wherein the holding fixture has a side with a handle, the coin insertion slot is affixed on the side with the handle.

18. The device as set forth in claim 17, wherein the holding fixture has a lock mounted on the side.

19. The device as set forth in claim 18, wherein the rails are slide-out rails.

20. The device as set forth in claim 19, further comprising: a coin outlet area.

21. The device as set forth in claim 20, further comprising: at least one coin outlet area including a filter which separates coins and other objects.

22. The device in as set forth in claim 21, wherein the coin outlet area has a fixed part and a moveable part, the moveable part being moveable to incline with respect to the fixed part.

23. The device in as set forth in claim 22, wherein the moveable part being mounted on the fixed part and swivels with respect to the fixed part, the moveable part includes a guide wheel, the holding fixture includes a guide and the guide wheel and the guide cooperate to enable coins to support the moveable part and enable coins to slide on the moveable part when the moveable part inclines.

24. The device in as set forth in claim 23, including a second filter to drain liquids.

25. The device as set forth in claim 23 further comprising: a sensor, the sensor detects liquid.

26. The device as set forth in claim 25 further comprising: a sensor and a controller, the sensor detects liquid in the device, and signals the controller when liquid is detected, the controller Preliminary Amendment Page of releases a corresponding warning in response to liquid detection by the sensor.

27. A device as set forth in claim 26 further comprising:
a particle sensor in communication with the controller, the particle sensor detects objects, which are not coins, and communicates with the controller to generate a service notification.

28. A device for accepting coins, comprising:
sliding rails;
a holding fixture mounted on the sliding rails, the holding fixture able to slide from an open configuration to a closed configuration;
the holding fixture includes a coin insertion slot for receiving individual coins, the coin insertion slot being accessible when the drawer is in the open configuration and when the drawer is in the closed configuration; and
the holding fixture includes a coin opening for simultaneously receiving multiple coins when the drawer is in the open configuration,
wherein sliding the holding fixture from the open configuration to the closed configuration enables multiple coins to simultaneously enter the device.

29. The device as set forth in claim 28, wherein the holding fixture has a side with a handle, the coin insertion slot is affixed on the side with the handle.

30. The device as set forth in claim 29, wherein the holding fixture has a lock mounted on the side.

31. The device as set forth in claim 28, further comprising: a coin outlet area having a fixed part and a moveable part attached to the fixed part, the moveable part rotates with respect to the fixed part to release coins.

32. The device as set forth in claim 31, wherein the moveable part includes a guide wheel to regulate movement of the moveable part.

33. The device as set forth in claim 28, wherein the moveable part includes a guide wheel to regulate movement of the moveable part to an incline that allows coins to slide from the coin outlet area.

34. A method for accepting coins, comprising:
opening a drawer having moveable part with a first opening and a fixed part with a second opening, wherein if the drawer is in an open position an insertion opening is established;
inserting a plurality of coins into the insertion opening; and
sliding the moveable part so that the first opening and the second opening coincide to deliver the coins into a coin outlet area.
